(19) United States
(12) Patent Application Publication
(10) Pub. No.: US 2023/0356405 A1
(43) Pub. Date: Nov. 9, 2023

(54) ROBOT CONTROL SYSTEM, AND CONTROL DEVICE

(71) Applicant: JOHNAN Corporation, Uji-shi, Kyoto (JP)

(72) Inventors: Kozo MORIYAMA, Kyoto (JP); Shin KAMEYAMA, Kyoto (JP); Truong Gia VU, Kyoto (JP); Lucas BROOKS, Kyoto (JP)

(21) Appl. No.: 18/246,499

(22) PCT Filed: Mar. 4, 2022
(86) PCT No.: PCT/JP2022/009344

§ 371 Date: Mar. 23, 2023

(30) Foreign Application Priority Data
Mar. 31, 2021 (JP) 2021-060234

(51) Int. Cl. B25J 9/16

(52) U.S. Cl. CPC B25J 9/1697; B25J 9/1664

(57) ABSTRACT

Provided is a robot control system (1) including a robot (200), at least one camera (300) and a control device (100). The control device specifies a posture of a part or a whole of a worker's body based on an image of the at least one camera, and causes the robot to execute a process according to the posture.

### TECHNICAL FIELD

The present invention relates to a technology for controlling robots.

### BACKGROUND ART

A technology for controlling a robot based on images captured by cameras have been known. For example, JP-A-2014-104527 (PTL 1) discloses a robot system, a program, a production system, and a robot. According to PTL 1, a robot system includes a robot for performing a production work together with an operator in a production system, an imaging information acquisition unit for acquiring imaging information from an imaging unit for imaging the operator, a robot control unit for controlling the robot based on the imaging information, and a display control unit for performing display control of a display unit for displaying a display image. First, the robot control unit detects a gesture of the operator based on the acquired imaging information and identifies a robot control command associated with the detected gesture. Then, the display control unit controls the display unit to display a notification image for notifying the operator of the robot control command identified by the robot control unit.

### CITATION LIST

### Patent Literature

PTL 1: JP-A-2014-104527

### SUMMARY OF INVENTION

### Technical Problem

An object of the present invention is to provide a robot control system and a control device that facilitate executions of a process desired by a worker.

### Solution to Problem

According to an aspect of the invention, there is provided a robot control system that includes a robot, at least one camera, and a control device. The control device specifies a posture of a part or a whole of a worker's body based on an image of the at least one camera, and causes the robot to execute a process according to the posture.

### Advantageous Effects of Invention

As described above, according to the present invention, it is possible to provide a robot control system and a control device that facilitate executions of a process desired by a worker.

### BRIEF DESCRIPTION OF THE DRAWINGS

FIG. 1 is a block diagram representing an overall configuration of a robot control system according to First Embodiment.

FIG. 2 is an image diagram representing correspondence data according to First Embodiment.

FIG. 3 is a flow chart representing information processing of robot control according to First Embodiment.

FIG. 4 is an image diagram representing an image for specifying the posture of the worker according to First Embodiment.

FIG. 5 is an image diagram representing correspondence data according to Second Embodiment.

FIG. 6 is a flow chart representing information processing of robot control according to Second Embodiment.

FIG. 7 is an image diagram representing a screen of the control device according to Third Embodiment.

FIG. 8 is an image diagram representing correspondence data according to Fourth Embodiment.

FIG. 9 is an image diagram representing a screen of the control device according to Fourth Embodiment.

FIG. 10 is a flow chart representing information processing of robot control according to Fourth Embodiment.

FIG. 11 is an image diagram representing correspondence data according to Fifth Embodiment.

FIG. 12 is an image diagram representing worker information data according to Fifth Embodiment.

FIG. 13 is a flow chart representing information processing of robot control according to Fifth Embodiment.

### DESCRIPTION OF EMBODIMENTS

The following describes embodiments of the present invention with reference to the accompanying drawings. In the following descriptions, like elements are given like reference numerals. Such like elements will be referred to by the same names, and have the same functions. Accordingly, detailed descriptions of such elements will not be repeated.

### First Embodiment

### <Overall Configuration of the Robot Control System>

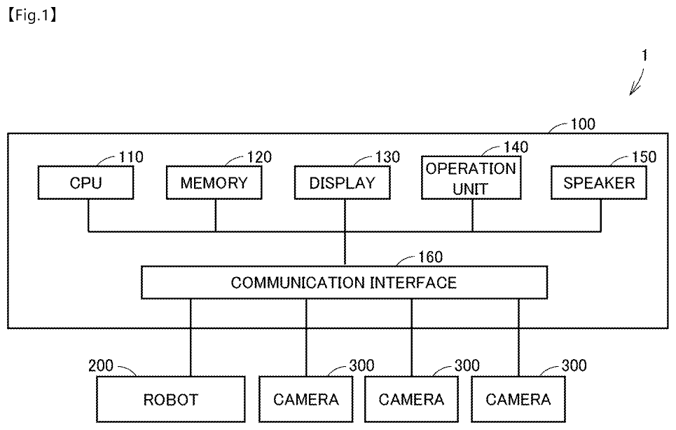

First, referring to FIG. 1, the overall configuration of a robot control system 1 according to this embodiment is described. The robot control system 1 includes, as main devices, a robot 200, one or a plurality of cameras 300, 300 . . . , and a control device 100 for controlling the motion of the robot 200 based on the captured image. A plurality of robots 200 may also be prepared.

The robot control system 1 according to the present embodiment is applied, for example, to a production site in a factory, and is configured to cause the robot 200 to perform a predetermined task at the production site. Further, in the robot control system 1 according to the present embodiment, the robot 200 is not partitioned by a fence or the like, a person can access the work area of the robot 200, and the person and the robot 200 are going to proceed to work together.

One or a plurality of cameras 300 may be a camera attached to the robot 200, or a camera fixed to a workbench, ceiling, or the like. Alternatively, one or a plurality of cameras 300 may be wearable cameras that are attached to the worker's body, work clothes, eyeglasses, a work cap, a helmet, or the like.

The control device 100 grasps the positions of the components, the current situation, etc. based on the images captured by the cameras 300, 300, . . . and causes the robot 200 to perform various tasks. A task may be, for example, a process of moving a workpiece at a certain point to another point, or a process of passing a tool suitable for the workpiece W to a worker.

The Control device 100 mainly includes a CPU 110, a memory 120, a display 130, an operation unit 140, a speaker 150 and a communication interface 160. The CPU 110 controls each part of the robot 200 and the control device 100 by executing programs stored in the memory 120. For example, the CPU 110 executes a program stored in the memory 120 and refers to various data to perform various types of information processing, which will be described later.

The memory 120 is implemented by various RAMs, various ROMs, and the like. The memory 120 stores programs executed by the CPU 110, such as the task of the robot 200, and data generated by the execution of the programs by the CPU 110, such as the operating state, the current position and the posture, and the target position of the robot 200.

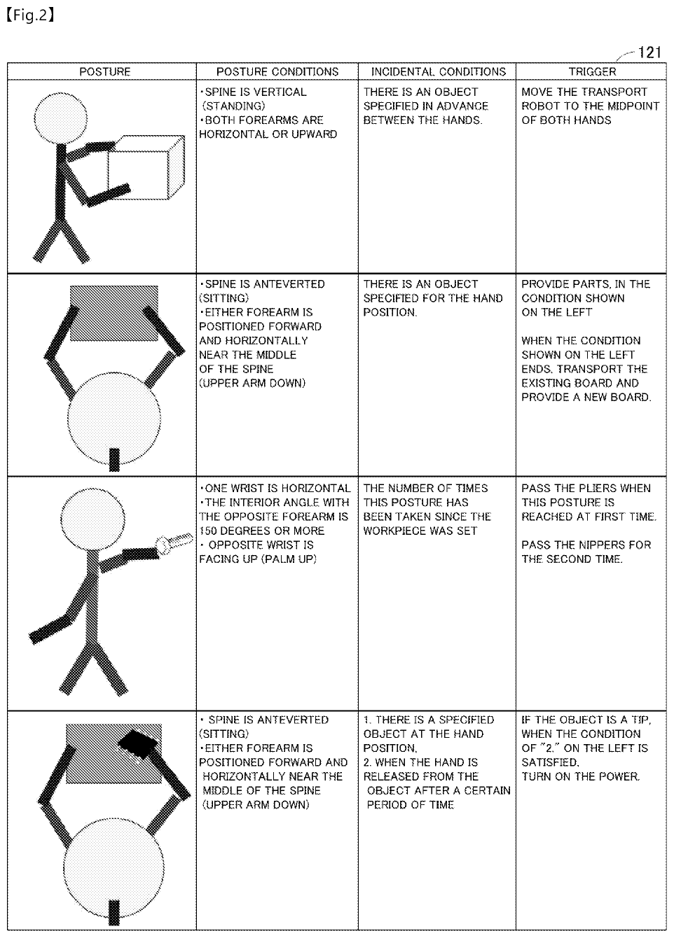

Specifically, in this embodiment, the memory 120 stores correspondence data 121 as shown in FIG. 2. The correspondence data 121 stores the correspondence relationship between the condition regarding the worker's posture, other incidental conditions, and the process to be executed by the robot 200.

Returning to FIG. 1, the display 130 displays texts and images based on signals from CPU 110.

The operation unit 140 receives instructions from the worker and inputs them to the CPU 110.

The speaker 150 outputs various sounds based on signals from the CPU 110.

Note that the display 130, the operation unit 140, and the speaker 150 may be implemented by other terminals.

The communication interface 160 is realized by a connector, an antenna, or the like, and exchanges various data with other devices such as the robot 200 and the cameras 300, 300 . . . via a communication cable, wireless LAN, or the like.

In this way, the CPU 110 of the control device 100, according to the robot control program in the memory 120, causes the robot 200 to perform various actions suitable for the current posture or motion of the worker via the communication interface 160 based on images acquired from the cameras 300, 300. . .

<Information Processing of the Control Device 100>

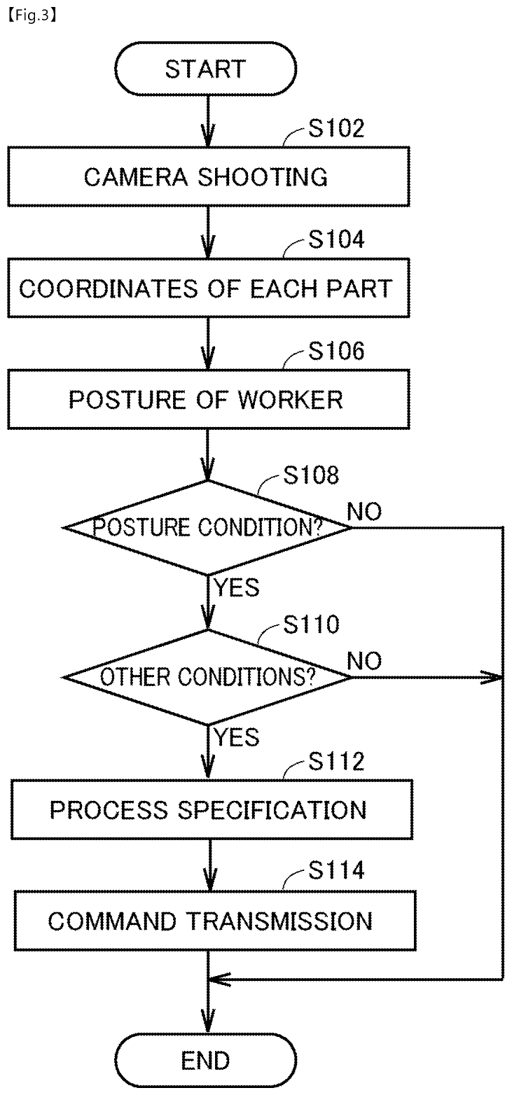

Information processing of the control device 100 in the present embodiment is described in detail below with reference to FIG. 3. The CPU 110 of the control device 100 reads out, for example, a program for causing the robot 200 to execute a task according to the program in the memory 120, and executes the following processing.

First, the CPU 110 acquires images captured by the cameras 300, 300, . . . via the communication interface 160 (step S102).

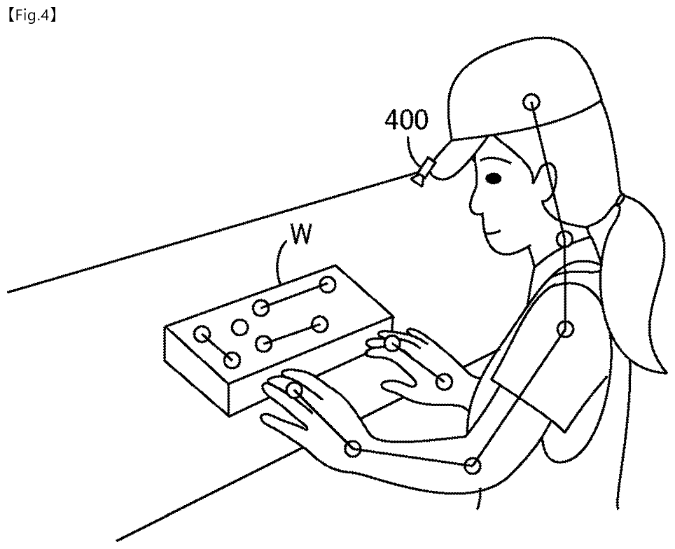

As shown in FIG. 4, the CPU 110 specifies the coordinates of each part of the worker's body based on the captured image (step S104).

For example, when using a three-dimensional camera such as an RGB-D camera, the CPU 110 adds depth information to the two-dimensional coordinates obtained above so that the three-dimensional coordinates of each part of the worker's body, the workpiece W and components are calculated as the coordinates of the first camera 300.

When a two-dimensional camera is used, the CPU 110 can detect the same point using a plurality of the cameras 300, 300, . . . As a result, the three-dimensional coordinates of each part of the worker's body, the workpiece W and components are calculated by using trigonometrical survey or the like.

Then, the CPU 110 specifies the posture of a part or the whole of the worker's body (step S106). For example, the CPU 110 calculates the angle of the worker's spine from vertical, the absolute angle of working arm, the relative angle between upper arm bone and forearm bone, the relative angle between the forearm bone and the back of the hand, the distance between right arm and left arm and the like.

The CPU 110 refers to the correspondence data 121 to determine whether a process corresponding to the posture of a part or the whole body specified this time is registered (step S108).

If the process corresponding to the posture of a part or the whole body specified this time is registered (YES in step S108), the CPU 110 refers to the correspondence data 121 and determines whether the other incidental conditions are satisfied on the basis of the images captured by the cameras 300, 300, . . . , the contents of the task currently being executed by the robot 200, and the like (step S110).

If the other incidental conditions are satisfied (YES in step S110), the CPU 110 specifies the corresponding process (step S112).

The CPU 110 transmits control commands to the robot 200 via the communication interface 160 (step S114).

The robot 200 performs tasks according to the commands from the control device 100.

### Second Embodiment

In the above embodiment, the process is executed based on the posture of a part or whole of the worker's body. In this embodiment, the process is specified based on the relative position between the position of a part of the worker's body or the position of the whole body of the worker and the position of the workpiece and/or components.

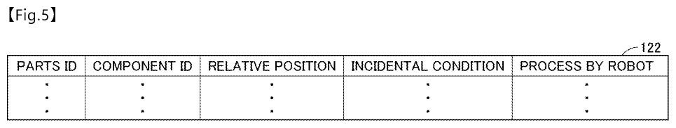

In this embodiment, the memory 120 of the control device 100 stores the correspondence data 122 as shown in FIG. 5. The correspondence data 122 stores the correspondence relationship between the identification information of the part of the worker's body, the identification information of the components, the relative position of the components with respect to the part of the worker's body, the other incidental conditions, and the process to be executed by the robot 200.

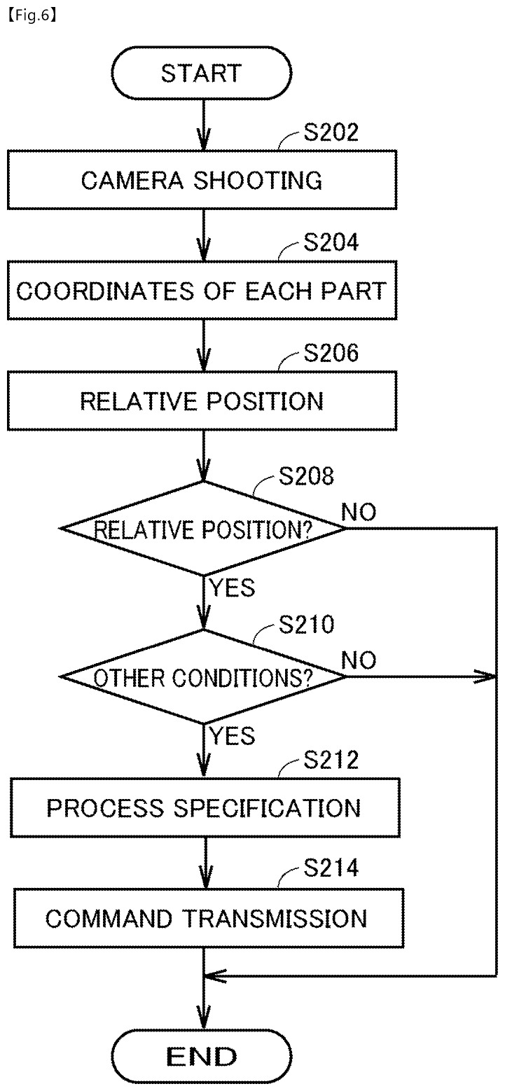

In the present embodiment, the CPU 110 of the control device 100 reads a program for causing the robot 200 to execute a task, for example, according to the program in memory 120, and executes the process shown in FIG. 6.

First, the CPU 110 acquires images captured by the cameras 300, 300, . . . via the communication interface 160 (step S202).

As shown in FIG. 4, the CPU 110 specifies the type and position of each part of the worker's body, and the type, model number and position of the component based on the captured image (step S204).

Then, the CPU 110 calculates the relative positions of the component with respect to the positions of the each parts of the worker's body (step S206). Note that the relative positions of the positions of each part of the worker's body with respect to the positions of the component may be calculated.

The CPU 110 refers to the correspondence data 122 to determine whether a process corresponding to the relative positions of the component with respect to the positions of each part of the worker's body is registered (step S208).

If the process corresponding to the relative position of the component with respect to the positions of each part of the worker's body is registered (YES in step S208), the CPU 110 refers to the correspondence data 122 to determine whether the other incidental conditions are satisfied on the basis of the contents of the task currently being executed by the robot 200, and the like (step S210).

If the other incidental conditions are satisfied (YES in step S210), the CPU 110 specifies the corresponding process (step S212).

The CPU 110 transmits control commands to the robot 200 via the communication interface 160 (step S214).

### Third Embodiment

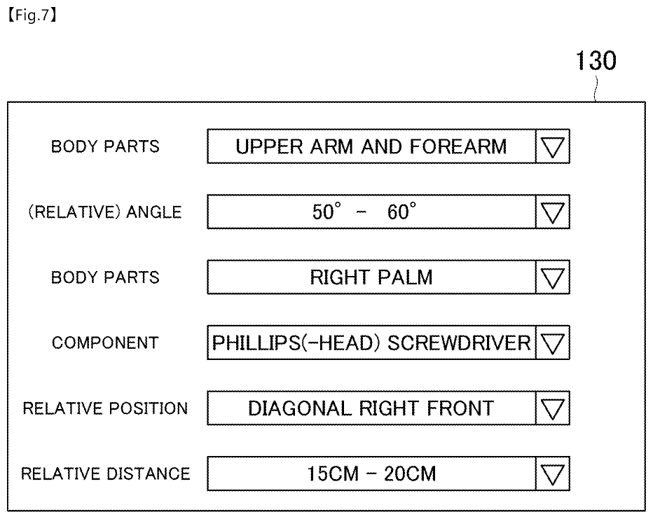

It is preferable that the worker can freely set the correspondence relationship according to the above embodiment. More specifically, the CPU 110 of the control device 100 displays a screen for setting the correspondence relationship as shown in FIG. 7 according to the program in the memory 120. The CPU 110 associates various data input by the worker or the like and registers them in the correspondence data 121 and 122.

### Fourth Embodiment

Furthermore, it is preferable that the posture conditions, relative position conditions, incidental conditions, and the like for executing the robot processing can be set for each worker. This is because different workers have different desirable working conditions. For example, the position and timing at which the screwdriver should be handed over may differ from worker to worker.

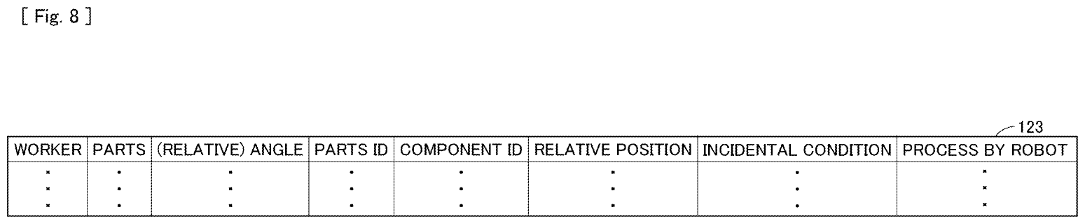

In this embodiment, the memory 120 of the control device 100 stores the correspondence data 123 as shown in FIG. 8. The correspondence data 123 includes the correspondence relationship between the information specifying the worker, the posture of the worker, the identification information of the part of the worker's body, the specifying information of the components, the relative position of the components with respect to the part of the worker's body, the other incidental conditions, and the process to be executed by the robot 200.

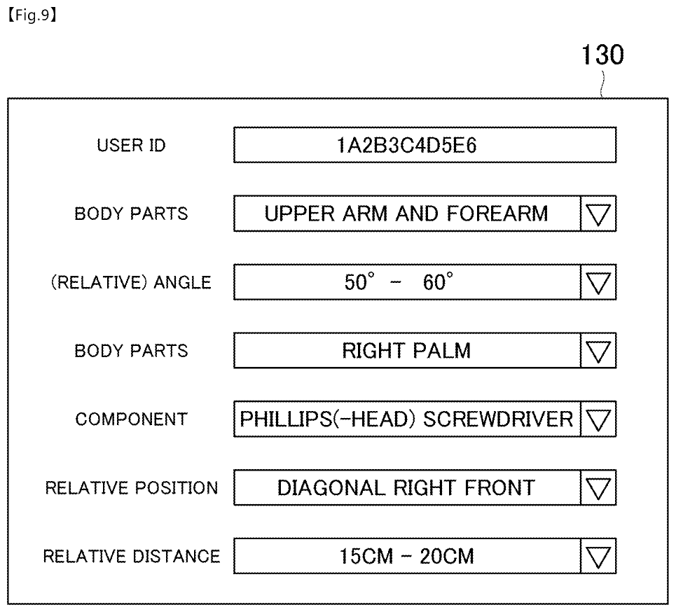

Then, the CPU 110 of the control device 100 displays the information for identifying the worker and a screen for setting the correspondence, as shown in FIG. 9, according to the program in the memory 120. The CPU 110 registers the data input by the worker or the like in the correspondence data 123.

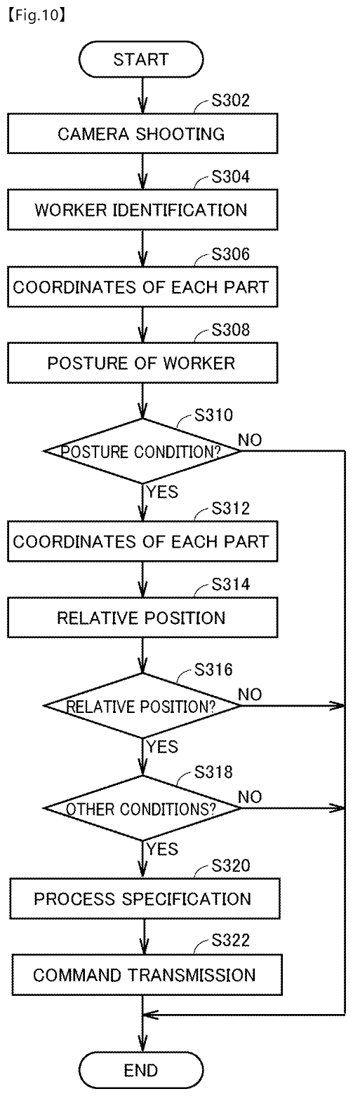

In the present embodiment, the CPU 110 of the control device 100 reads a program for causing the robot 200 to execute a task, for example, according to the program in memory 120, and executes the process shown in FIG. 10.

First, the CPU 110 acquires images captured by the cameras 300, 300, . . . via the communication interface 160 (step S302).

The CPU 110 identifies the worker by acquiring the feature data of the worker based on the captured image (step S304).

As shown in FIG. 4, the CPU 110 specifies the coordinates of each part of the worker's body based on the captured image (step S306).

The CPU 110 specifies the posture of each part based on the coordinates of each part (step S308).

The CPU 110 refers to the correspondence data 121 to determine whether the process corresponding to the posture of the worker is registered in association with the identified worker (step S310).

If the process corresponding to the worker's posture is registered (YES in step S310), the CPU 110, as shown in FIG. 4, specifies the type and position of each part of the worker's body, and the type, model number and position of the component based on the captured image (step S312).

Then, the CPU 110 calculates the relative positions of the component with respect to the positions of the each parts of the worker's body (step S314).

The CPU 110 refers to the correspondence data 122 to determine whether the process corresponding to the relative positions of the component with respect to the positions of the each parts of the worker's body is registered in association with the identified worker (step S316).

If the process corresponding to the relative positions of the component with respect to the positions of the each parts of the worker's body is registered (YES in step S316), the CPU 110 refers to the correspondence data 122 to determine whether the other incidental conditions are satisfied in association with the identified worker on the basis of the contents of the task currently being executed by the robot 200, and the like (step S318).

If the other incidental conditions are satisfied (YES in step S318), the CPU 110 specifies the corresponding process (step S320).

The CPU 110 transmits control commands to the robot 200 via communication interface 160 (step S322).

### Fifth Embodiment

Alternatively, it is preferable that the posture conditions, relative position conditions, incidental conditions, and the like for executing robot processing can be set for each worker's physique. This is because different workers have different desirable working conditions depending on the physique of the worker. For example, the posture in which the workers want the screwdriver handed over depends on the length of their arm.

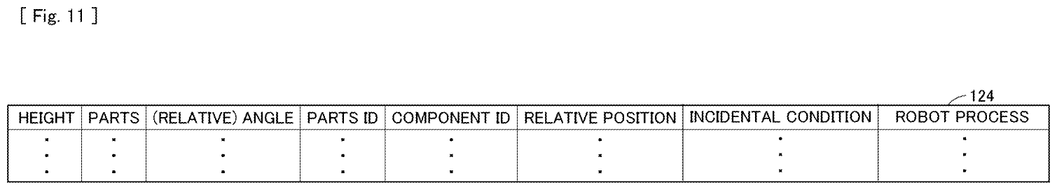

Specifically, the memory 120 of the control device 100 may store the correspondence data 124 as shown in FIG. 11. In the present embodiment, the correspondence data 124 may store the correspondence relationship, for each height, between the posture of the worker, the identification information of the part of the worker's body, the specifying information of the components, the relative position of the components with respect to the part of the worker's body, the other incidental conditions, and the process to be executed by the robot 200.

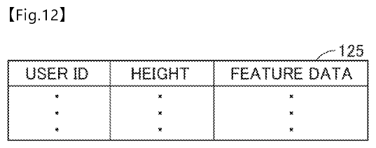

Then, the memory 120 may store the worker information data 125 as shown in FIG. 12. The worker information data 125 stores the correspondence relationship between feature data and height of the worker for each worker.

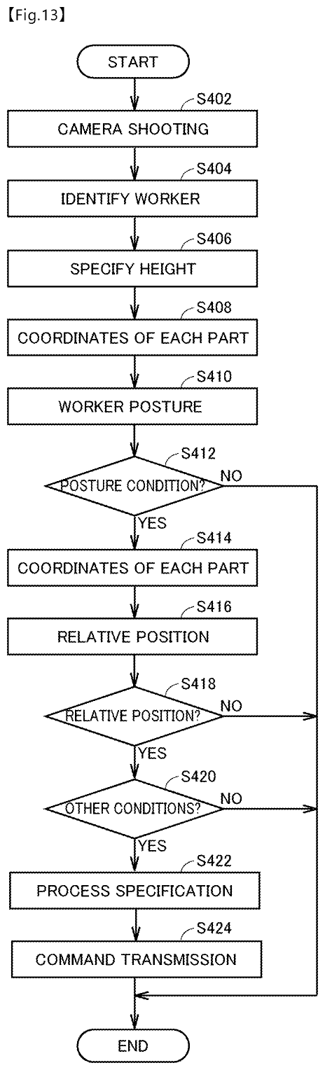

In the present embodiment, the CPU 110 of the control device 100 reads a program for causing the robot 200 to execute a task, for example, according to the program in the memory 120, and executes the process shown in FIG. 13.

First, the CPU 110 acquires images captured by the cameras 300, 300, . . . via the communication interface 160 (step S402).

The CPU 110 identifies the worker by acquiring the feature data of the worker based on the captured image (step S404).

The CPU 110 refers to the worker information data 125 and specifies the height of the worker (step S406).

As shown in FIG. 4, the CPU 110 specifies the coordinates of each part of the worker's body based on the captured image (step S408).

As shown in FIG. 4, the CPU 110 specifies the posture of each part of the worker's body (step S410).

The CPU 110 refers to the correspondence data 121 to determine whether the process corresponding to the posture of the worker associated with the height of the worker is registered (step S412).

If the process corresponding to the worker's posture is registered (YES in step S412), the CPU 110, as shown in FIG. 4, specifies the type and position of each part of the worker's body, and the type, model number and position of the component based on the captured image (step S414).

The CPU 110 then calculates the relative positions of the component with respect to the positions of the each parts of the worker's body (step S416).

The CPU 110 refers to the correspondence data 122 to determine whether the process corresponding to the relative position of the component with respect to the positions of the each part of the worker's body, which is associated with the height of the worker, is registered (Step S418).

If the process corresponding to the relative position of the component with respect to the positions of each part of the worker's body is registered (YES in step S418), the CPU 110 refers to the correspondence data 122 to determine whether the other incidental conditions are satisfied in association with the identified worker on the basis of the contents of the task currently being executed by the robot 200, and the like (step S420).

If the other incidental conditions are satisfied (YES in step S420), the CPU 110 specifies the corresponding process (step S422).

The CPU 110 transmits control commands to the robot 200 via the communication interface 160 (step S424).

### Sixth Embodiment

Other devices may perform a part or all of the role of each device such as the control device 100 and the robot 200 of the robot control system 1 of the above embodiment. For example, the role of the control device 100 may be partially played by the robot 200, the role of the control device 100 may be played by a plurality of personal computers, or the information processing of the control device 100 may be performed by a server on the cloud.

<Review>

In the above embodiments, a robot control system is provided that includes a robot, at least one camera and a control device. The control device specifies a posture of a part or a whole of a worker's body based on an image of the at least one camera and causes the robot to execute a process according to the posture.

Preferably, as the posture, the control device specifies an inclination of the worker's spine based on the images of the at least one camera.

Preferably, as the posture, the control device specifies a relative angle between a first bone and a second bone of the worker based on the images of the at least one camera.

Preferably, the control device stores the posture corresponding to the process for each worker.

In the above embodiments, a control device is provided that includes a communication interface for communicating with a robot and at least one camera, a memory and a processor. The processor specifies a posture of a part or a whole of a worker's body based on an image of the at least one camera and causes the robot to execute a process according to the posture.

In the above embodiments, a robot control system is provided that includes a robot, at least one camera and a control device. The control device specifies a position of a part or a whole of a worker's body based on an image of the at least one camera and causes the robot to execute a process according to the position.

In the above embodiments, a robot control system is provided that includes a communication interface for communicating with a robot and at least one camera, a memory and a processor. The processor specifies a position of a part or a whole of a worker's body based on an image of the at least one camera and causes the robot to execute a process according to the position.

It should be considered that the embodiments disclosed this time are illustrative in all respects and not restrictive. The scope of the present invention is indicated by the scope of the claims rather than the above description, and is intended to include all modifications within the scope and meaning equivalent to the scope of the claims.

### REFERENCE SIGNS LIST

1: robot control system
100: control device
110: CPU
120: memory
121: correspondence data
122: correspondence data
123: correspondence data
124: correspondence data
125: worker information data
130: display
140: operation unit
150: speaker
160: communication interface
200: robot
300: camera

1. A robot control system, comprising:
a robot;
at least one camera; and
a control device that specifies a posture of a part or a whole of a worker's body based on an image of the at least one camera, and causes the robot to execute a process according to the posture.

2. The robot control system according to claim 1,
wherein, as the posture, the control device specifies a relative angle between a first bone and a second bone of the worker based on the images of the at least one camera.

3. The robot control system according to claim 1,
wherein the control device stores the posture corresponding to the process for each worker.

4. A control device, comprising:
a communication interface for communicating with a robot and at least one camera;
a memory; and
a processor that specifies a posture of a part or a whole of a worker's body based on an image of the at least one camera, and causes the robot to execute a process according to the posture.

5. A robot control system, comprising:
a robot;
at least one camera; and
a control device that specifies a position of a part or a whole of a worker's body based on an image of the at least one camera, and causes the robot to execute a process according to the position.

6. (canceled)
